(19) United States
(12) Patent Application Publication
(10) Pub. No.: US 2025/0245326 A1
(43) Pub. Date: Jul. 31, 2025

(54) Graph Vector Variation Driven Data Corruption Detection

(71) Applicant: NetApp, Inc., San Jose, CA (US)

(72) Inventors: Muneem Shahriar, Sunnyvale, CA (US); Mesfin Dema, Allen, TX (US); Arunkumar Gururajan, Sammamish, WA (US); Phani Srikanth Bhavani Sankar, Hyderabad (IN); Jian Jian, Cupertino, CA (US); Yogita Verma, Bangalore (IN)

(21) Appl. No.: 18/917,318

(22) Filed: Oct. 16, 2024

Related U.S. Application Data
(63) Continuation-in-part of application No. 18/785,421, filed on Jul. 26, 2024.
(60) Provisional application No. 63/625,825, filed on Jan. 26, 2024.

(30) Foreign Application Priority Data
Apr. 23, 2024 (IN) 202441032106

(51) Int. Cl. G06F 21/56; G06F 16/583

(52) U.S. Cl. CPC G06F 21/565; G06F 16/5846

(57) ABSTRACT

Disclosed herein are methods, systems, and apparatus for the detection of data integrity anomalies indicative of malware for a datastore of an organization. To identify an anomaly in a file, a portion of a file is identified to be used in a vector comparison. The portion can comprise sentences or paragraphs for text files, entries, rows, or columns for spreadsheet files, or some other divisible portion of a file. A vector having multiple dimensions is generated for the portion based on the content in the portion. Each dimension of the multiple dimensions corresponds to a feature of the portion. A variation is determined between the vector and one other vector associated with one other portion of the file. One or more actions to take with respect to the file is determined based on the variation, such as malware mitigation, and the action is performed with respect to the file

### CROSS REFERENCE TO RELATED APPLICATIONS

This application claims priority to U.S. Non-provisional patent application Ser. No. 18/785,421, titled “VECTOR VARIATION DRIVEN MALWARE CORRUPTION DETECTION,” filed Jul. 26, 2024, which claims priority to U.S. Provisional Patent Application No. 63/625,825, titled “IDENTIFICATION AND MANAGEMENT OF DATA INTEGRITY ANOMALIES IN FILES,” the contents of which are incorporated by reference in their entirety for all purposes.

### TECHNICAL FIELD

Aspects of the disclosure are generally related to the field of computing hardware and software, and more specifically, to data corruption detection technology.

### BACKGROUND

Organizations deploy cybersecurity measures such as regular software updates, network security protocols, and user training to prevent malware from becoming active in a computing network or a database. While these security measures provide a measure of protection for an organization's assets, when an attack does occur, difficulties arise in identifying the scope of the attack and the data modified as part of the attack.

Cybersecurity attacks can vary in method, sophistication, and scope, and may target a variety of network or database locations. Where some attacks modify all of the data in a targeted location, other attacks modify only some fraction of the data in the targeted location. An attack that partially modifies a target file's data can cause similarly disruptive effects as an attack that modifies all of the target file's data but can be additionally difficult to evaluate because of the relatively small effect partial modification may have on a file. As such, cybersecurity attacks, and particularly cybersecurity attacks employing partial modification of targeted data, remain a challenge for cybersecurity measures. Accordingly, improvements are needed in the field of cybersecurity and particularly in the field of cybersecurity attack detection.

### SUMMARY

Described herein are methods, systems, and apparatus for the detection of data integrity anomalies associated with data corruption in a datastore of an organization. To support data integrity and identify the effect of various data corruptions on files of the datastore, the data storage computing system includes software for executing a corruption detection process that directs the computing system to identify variations in the content of a particular file. A variation in the content of a file refers to a discrepancy between one portion of the file and the other portions of the file. For example, a malware threat could change the content of a paragraph in a document such that the modified content is unrelated to the text document as whole. An unrelated paragraph in a document constitutes a data integrity anomaly indicative of the presence of malware. In another example, an erroneous copy and paste may result in a variation to the content of the file. In some other examples, a flawed software update may result in a variation in file content.

To identify deviant content in a file, the computing system is instructed to identify a portion of a file to be used in a vector comparison. The portion can comprise one or more sentences or one or more paragraphs in the case of a text file, can comprise one or more entries, one or more rows, or one or more columns in a spreadsheet file, or can comprise some other divisible portion of a file.

The computing system is instructed to generate a vector having multiple dimensions for the portion based on the content in the portion. Each dimension of the multiple dimensions corresponds to a feature of the portion of the file. After the vector is generated, the computing system is instructed to determine a variation between the vector and one otter vector associated with one other portion of the file. The variation between the vectors is representative of the change in meaning that the modified file portion has undergone. The computing system is then instructed to determine, based on the variation, an action to take with respect to the file, and to perform the action.

This Summary introduces a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates a computing environment in an implementation.

FIG. 2 illustrates a data corruption detection process in an implementation.

FIG. 3A illustrates an operational scenario in an implementation.

FIG. 3B illustrates another operational scenario in an implementation.

FIG. 3C illustrates another operational scenario in an implementation.

FIG. 4A illustrates another computing environment in an implementation.

FIG. 4B illustrates another computing environment in further detail in an implementation.

FIG. 5 illustrates an application of malware assessment process in an implementation.

FIG. 6 illustrates another computing environment in an implementation.

FIG. 7 illustrates another data corruption detection process in an implementation.

FIG. 8 illustrates a computing system in an implementation.

### DETAILED DESCRIPTION

Described herein are methods, systems, and apparatus for the detection of data integrity anomalies associated with malware for a datastore of an organization. In an organization, a data storage computing system is deployed that provides data storage service, integrated data service, and cloud operations service in association with a datastore. The data storage computing system is local or private to the organization and enables these services through features that support various storage protocols, data tiering, deduplication, encryption, high availability, amongst other potential features.

Here, to support data integrity and identify the effect of different attacks on files of the datastore, the data storage computing system includes software for identifying variations in the content of a particular file. For example, a threat could change the content of paragraphs in a document, such that the new content is unrelated to the text document as whole.

To identify deviant content in a file, the computing system is instructed to identify a portion of a file to be used in a vector comparison. The portion can comprise sentences or paragraphs in the case of a text file, can comprise entries, rows, or columns in a spreadsheet file, or can comprise some other divisible portion of a file.

The computing system is instructed to generate a vector having multiple dimensions for the portion based on the content in the portion. Vectors play a crucial role as the fundamental building blocks for representing data. Each data point is often represented as a vector in a high-dimensional space, where each dimension corresponds to a feature or attribute of the data. For example, for a text file, a vector is generated for a paragraph that represents word choice information, subject matter information, data points (e.g., numerical values), or other information about the paragraph.

After the vector is generated, the computing system is instructed to determine a variation between the vector and one other vector associated with one other portion of the file. To determine a variation, the computing system is instructed to compare vectors associated with different portions of the file to determine whether the vector comparison exceeds a threshold amount. In some embodiments, the threshold amount is determined heuristically from the original state of the file (i.e., before any form of data corruption has occurred). In some embodiments, the threshold amount is determined based on distances between vectors for various pairs of portions of the file. In such embodiments, the threshold amount exceeds the greatest distance between vectors for any pair of portions of the file. If the vector for a first paragraph in a set of five paragraphs exceeds a threshold amount, then the computing system will classify the first paragraph as an anomaly in the text file. Once the anomaly, which is indicative of a malware attack or some other form of data corruption, is identified, the computing system is instructed to determine an action with respect to the file and to perform the action. The action is used to notify an administrator or user of the anomaly, to move the file to a quarantine zone, to prevent future data losses in case active users write to the same file, to prevent the file from being stored in the datastore, to revert the file to a previous version, or to provide some other action with respect to the file.

In some embodiments, the action the computing system is instructed to determine, and initiate, comprises a malware mitigation process. In such an embodiment, performing the action comprises performing malware mitigation, which comprises checking the file having the anomaly for evidence of a malware event. In some embodiments, the action comprises editing assistance. In such an embodiment, performing the action comprises performing editing assistance, which comprises checking the file having the anomaly for editing errors.

In some embodiments, the portion of the file comprises a text string. In such embodiments, the multiple dimensions comprise one or more features of the text string. Here, generating the vector comprises obtaining a feature value for each of the one or more characteristics of the text string and using the feature values as data points for the vector. Any subset of the text string may be used to create the feature vector. The feature vector could be created at a character level, a word level, a phrase level, a sentence level, an entire document paragraph, or a combination thereof. In some other embodiments, the portion of the file comprises a text string having features that include one or more semantic features, one or more linguistic features, or a combination thereof. In such embodiments, a semantic feature engine is queried with the portion and returns one or more semantic features. Similarly, a linguistic feature engine is queried with the portion and returns one or more linguistic features.

In some embodiments, a magnitude of the variation is calculated. The variation between vectors refers to the magnitude of the change in meaning of the text versus the modified text. The magnitude of variation between vectors is determined via vector comparison analysis. In such embodiments, determining the action based on the variation comprises determining the action based on the magnitude of the variation. In some examples, determining the action based on the magnitude of the variation comprises selecting an action from a set of potential actions based on the magnitude of the variation. Examples of such potential actions include no responsive action, malware mitigation, editing assistance, action for a variation below minimum limit, and action for a variation above maximum limit.

Various embodiments of the present technology provide for a wide range of technical effects, advantages, and/or improvements to computing systems and components. For example, various embodiments may include one or more of the following technical effects, advantages, and/or improvements: 1) non-routine and unconventional detection of data integrity anomalies in different types of files; and 2) non-routine and unconventional use of calculated vectors from content of a file to determine whether anomalies exist in a file.

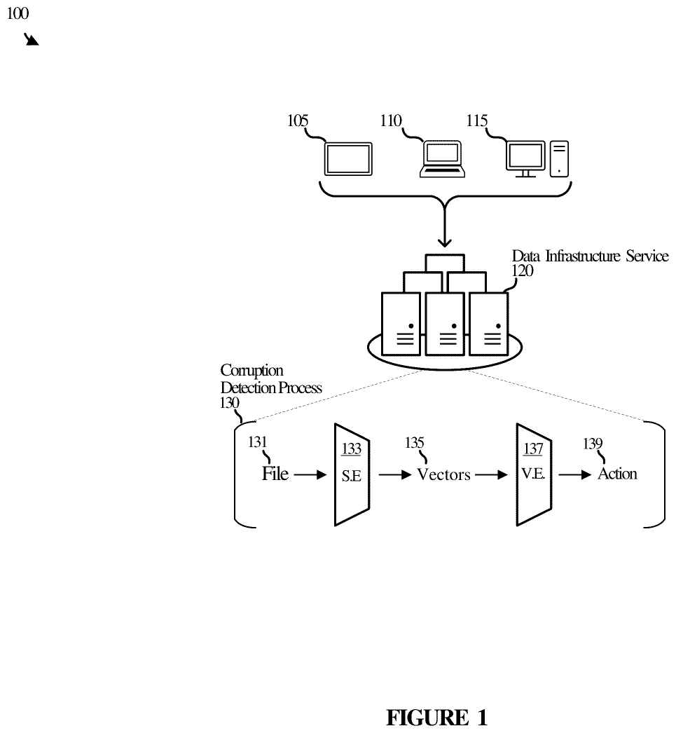

FIG. 1 illustrates computing environment 100 in an implementation. Computing environment 100 includes user device 105, user device 110, and data infrastructure service 120. Data infrastructure service 120 includes data corruption detection process 130, which further includes file 131, security engine 133, vectors 135, variation engine 137, and action 139. Data corruption detection process 130 is generally representative of the data corruption detection methods as disclosed herein, the steps of which may not necessarily be performed in the given order. Additional steps may exist in the data corruption detection method disclosed herein but have been omitted from data corruption detection process 130 for clarity. Notably, data corruption detection may detect data corruption resulting from malware, or from other issues, such as erroneous copy and paste errors, flawed software updates, and the like.

Computing environment 100 is generally representative of a computing environment in which a data infrastructure service, such as data infrastructure service 120, operates. In an example, computing environment 100 is an enterprise environment.

Each user device 105, user device 110, and user device 115 are generally representative of a user device sufficient to communicate with data infrastructure service 120. User device 105 is illustrated as a tablet computer, user device 110 is illustrated as a laptop computer, and user device 115 is illustrated as a desktop computer. Note that any number of user devices may communicate with data infrastructure service 120 and may be comprised of any number of a variety of computing devices, of which user device 105, user device 110, and user device 115 are generally representative.

Data infrastructure service 120 is representative of a computing device that enables these services through features that support various storage protocols, data tiering, deduplication, encryption, high availability, amongst other potential features. In computing environment 100, an organization uses data infrastructure service 120 to provide data storage service, integrated data service, and cloud operations service. One example of integrated data service is data corruption detection process 130.

Data corruption detection process 130 is illustrated at a high level by constituent elements file 131, security engine 133, vectors 135, variation engine 137, and action 139. Each of file 131, security engine 133, vectors 135, variation engine 137, and action 139 correspond to a step in data corruption detection process 130. File 131 corresponds to the identification of a file to be used in a vector comparison. Security engine 133 corresponds to the generation of a vector for a portion of the identified file. Vectors 135 corresponds to the vector for the portion of the file and one other vector used as the basis for the vector comparison. Variation engine 137 corresponds to the determination of a variation between the vector and the one other vector. Based on the determined variation, variation engine 137 determines an action to take with respect to the file. In some embodiments, variation engine 137 solely outputs the magnitude of the variation. In such embodiments, an action policy engine may determine what action to take based on the magnitude and any relevant policies at the user and system levels. Action 139 corresponds to the performing of the action with respect to the file.

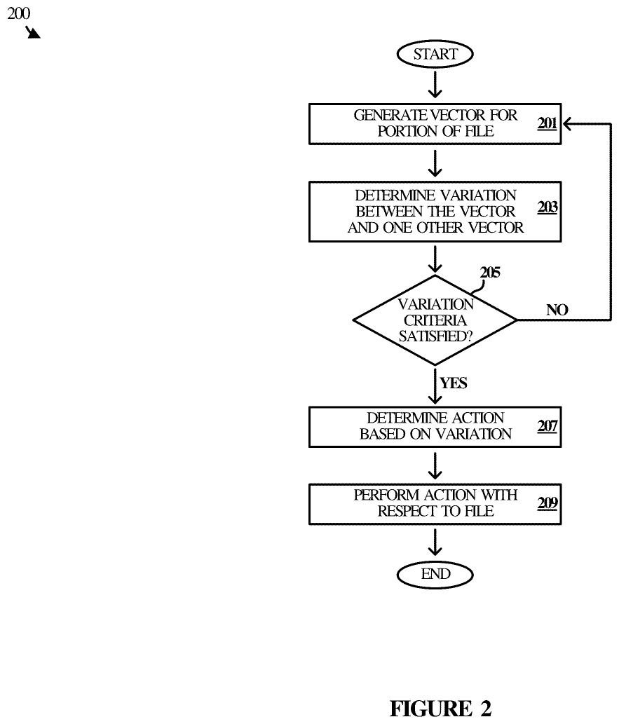

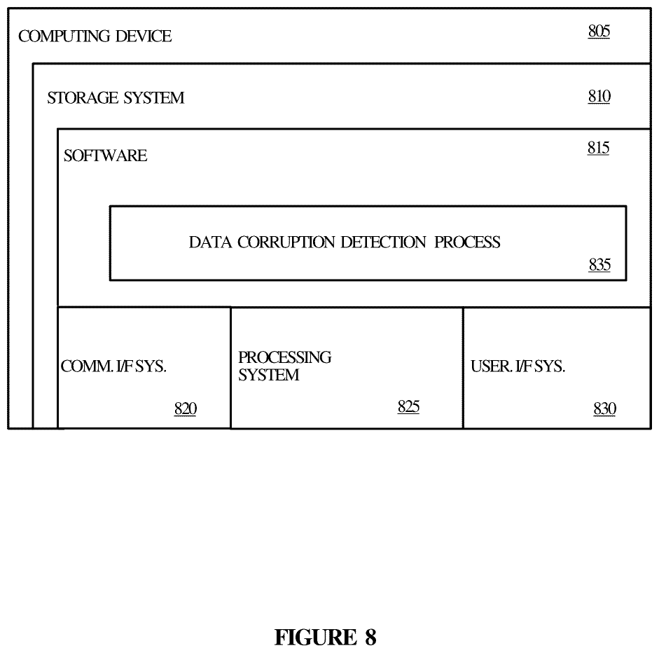

FIG. 2 illustrates data corruption detection process 200 in an implementation. Data corruption detection process 200 may be implemented in program instructions in the context of the software and/or firmware elements of data infrastructure service 120. The program instructions, when executed by one or more processing devices of one or more computing systems (e.g., computing device 805 in FIG. 8), direct the one or more computing systems to operate as follows, referring parenthetically to the steps in FIG. 2, and in the singular to a computing device for the sake of clarity.

To begin, a security engine of a data infrastructure service generates a vector having multiple dimensions for a portion of a file to be used in a vector comparison (step 201). In some embodiments, the security engine is tasked with identifying modifications to a file, on which the vector is calculated. Each dimension of the multiple dimensions of the vector corresponds to a feature of the portion of the file. A variation engine of the data infrastructure service determines a variation between the vector and one other vector based on one other portion of the file (step 203). The variation engine determines if the vector comparison exceeds a threshold criteria by performing a comparison of the vector and one other vector (step 205). Where the variation between the vector and one other vector does not exceed a threshold criteria, the security engine of the data infrastructure service repeats the data corruption detection process. Where the variation between the vector and one other vector does exceed a threshold criteria, the security engine determines an action to take with respect to the file based on the variation (step 207). Notably, particular actions can be taken specifically when the variation is below a minimum limit and when the variation is above a maximum limit. The variation engine performs the action with respect to the file (step 209).

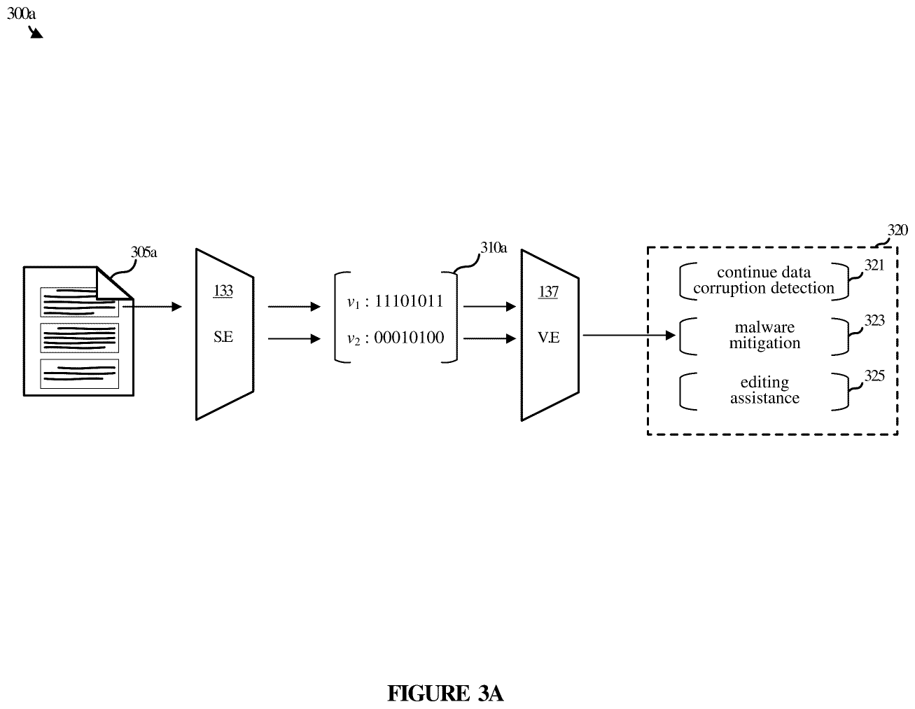

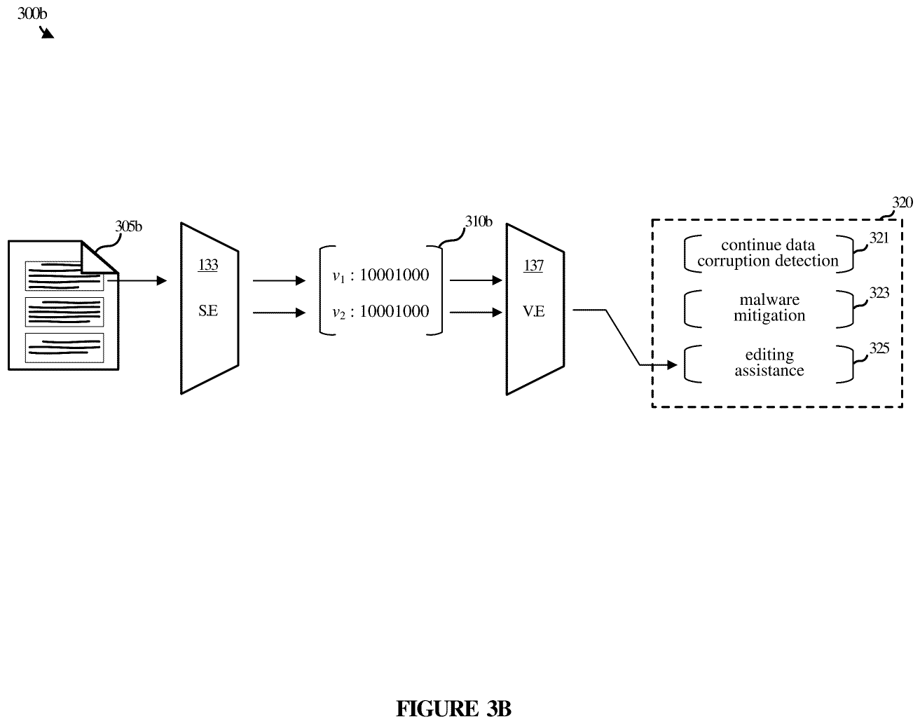

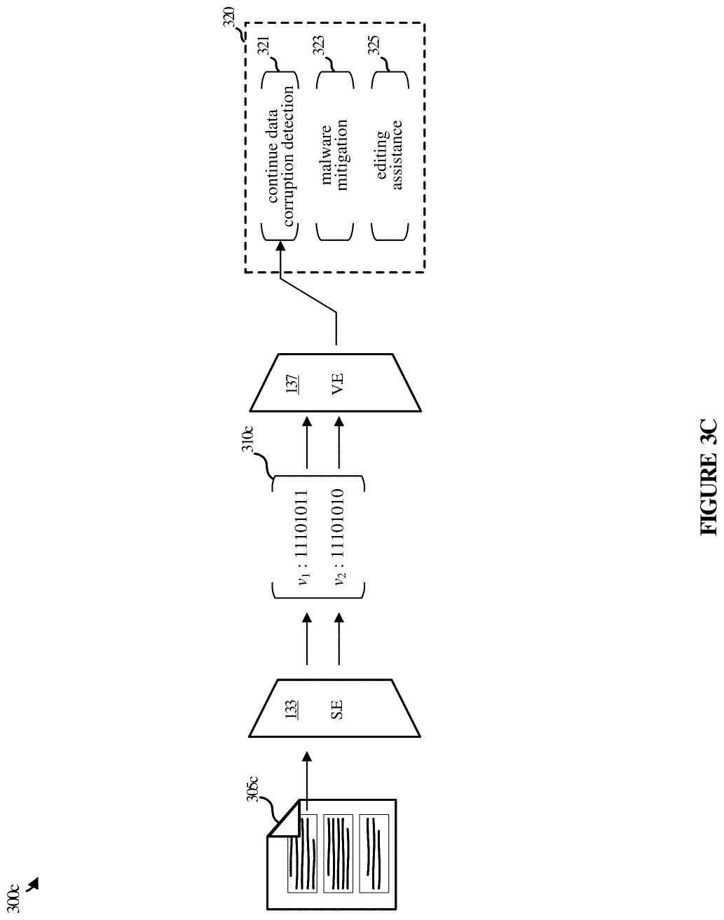

FIG. 3A illustrates operational scenario 300a in an implementation related to an application of data corruption detection process 200 in the context of computing environment 100 in an implementation. Operational scenario 300a includes file 305a, security engine 133, vectors 310a, variation engine 137, and set of potential actions 320. Set of potential actions 320 includes continue data corruption detection 321, malware mitigation 323, and editing assistance 325. File 305a, vectors 310a, and set of potential actions 310 generally correspond to file 131, vectors 135, and action 139 of FIG. 1, respectively. Security engine 133 and variation engine 137 are the same elements as security engine 133 and variation engine 137 of FIG. 1.

File 305a is representative of a file identified to be used in a vector comparison. File 305a is illustrated to include a number of individual paragraphs. In operational scenario 300a, file 305a is divided into the individual paragraphs, which are used as the basis for selecting a portion. The portion of file 305a is fed to security engine 133, which generates a vector for the portion. Security engine 133 generates a vector for the portion by submitting the portion to a number of feature engines, each of which is associated with a different feature of the portion. In response to receiving the portion, each of the feature engines determines a value for the portion. Each feature of the portion represents a dimension in vector space and each value received from each of the number of feature engines is a data point constituent of the vector. The vector generated for the portion of the file is represented by vectors 310a. Vectors 310a represents both the vector for the portion of the file and one other vector for one other portion of the file. Both the vector and the one other vector are submitted to variation engine 137 to determine a variation. The variation determined by variation engine 137 is the basis for selecting an action from set of potential actions 320.

In an example operation, file 305a is a text file containing an anomaly. Security engine 133 identifies a portion of file 305a and generates a vector for the portion, represented by v₁ of vectors 310a. The one other vector is represented by v₂ of vectors 310a. Variation engine 137 evaluates the vectors to determine a variation. In the ongoing example, variation engine 137 determines that the variation is high and above a maximum predetermined limit. In this example, the high variation is the result of a malicious modification, such as an encryption process or content revision by a malware attack. Based on the outcome of the variation determination, variation engine 137 determines an action to take from list of potential actions 320. The variation here was determined to be above a maximum limit, resulting in the determination that the action to take should be malware mitigation 323. Variation engine 137 then initiates malware mitigation 323. In some embodiments, an action policy engine may initiate responsive action.

FIG. 3B illustrates another operational scenario, represented by operational scenario 300b, in an implementation related to an application of data corruption detection process 200 in the context of computing environment 100 in an implementation. Operational scenario 300b includes file 305b, security engine 133, vectors 310b, variation engine 137, and set of potential actions 320. Set of potential actions 320 includes continue data corruption detection 321, malware mitigation 323, and editing assistance 325. File 305b, vectors 310b, and set of potential actions 310 generally correspond to file 131, vectors 135, and action 139 of FIG. 1, respectively. Security engine 133 and variation engine 137 are the same elements as security engine 133 and variation engine 137 of FIG. 1.

File 305b is representative of a file identified to be used in a vector comparison. File 305b is illustrated to include a number of individual paragraphs. In operational scenario 300b, file 305b is divisible into individual paragraphs, which are used as the basis for selecting a portion. The portion of file 305b is fed to security engine 133, which generates a vector for the portion. Security engine 133 generates a vector for the portion by submitting the portion to a number of feature engines, each of which is associated with a different feature of the portion. In response to receiving the portion, each of the feature engines determines a value for the portion. Each feature of the portion represents a dimension in vector space and each value received from each of the number of feature engines is a data point constituent of the vector. The vector generated for the portion of the file is represented by vectors 310b. Vectors 310b represents both the vector for the portion of the file and one other vector for one other portion of the file. Both the vector and the one other vector are submitted to variation engine 137 to determine a variation. The variation determined by variation engine 137 is the basis for selecting an action from set of potential actions 320.

In an example operation, file 305b is a text file containing an anomaly. Security engine 133 identifies a portion of file 305b and generates a vector for the portion, represented by v₁ of vectors 310b. The one other vector is represented by v₂ of vectors 310b. Variation engine 137 evaluates the vectors to determine a variation. In the ongoing example, variation engine 137 determines that the variation is low and below a minimum predetermined limit. In this example, the low variation is the result of an editing anomaly, such as a mistaken copy and paste duplication of an existing paragraph in the document. Based on the outcome of the variation determination, variation engine 137 determines an action to take from list of potential actions 320. The variation here was determined to be below a minimum limit, resulting in the determination that the action to take should be editing assistance 325. Variation engine 137 then performs editing assistance 325.

FIG. 3C illustrates another operational scenario, represented by operational scenario 300c, in an implementation related to an application of data corruption detection process 200 in the context of computing environment 100 in an implementation. Operational scenario 300c includes file 305c, security engine 133, vectors 310c, variation engine 137, and set of potential actions 320. Set of potential actions 320 includes continue data corruption detection 321, malware mitigation 323, and editing assistance 325. File 305c, vectors 310c, and set of potential actions 310 generally correspond to file 131, vectors 135, and action 139 of FIG. 1, respectively. Security engine 133 and variation engine 137 are the same elements as security engine 133 and variation engine 137 of FIG. 1.

File 305c is representative of a file identified to be used in a vector comparison. File 305c is illustrated to include a number of individual paragraphs. In operational scenario 300c, file 305c is divisible into individual paragraphs, which are used as the basis for selecting a portion. The portion of file 305c is fed to security engine 133, which generates a vector for the portion. Security engine 133 generates a vector for the portion by submitting the portion to a number of feature engines, each of which is associated with a different feature of the portion. In response to receiving the portion, each of the feature engines determines a value for the portion. Each feature of the portion represents a dimension in vector space and each value received from each of the number of feature engines is a data point constituent of the vector. The vector generated for the portion of the file is represented by vectors 310c. Vectors 310c represents both the vector for the portion of the file and one other vector for one other portion of the file. Both the vector and the one other vector are submitted to variation engine 137 to determine a variation. The variation determined by variation engine 137 is the basis for selecting an action from set of potential actions 320.

In an example operation, file 305c is a text file that does not contain an anomaly. Security engine 133 identifies a portion of file 305c and generates a vector for the portion, represented by v₁ of vectors 310c. The one other vector is represented by v₂ of vectors 310c. Variation engine 137 evaluates the vectors to determine a variation. In the ongoing example, variation engine 137 determines that the variation is above a minimum predetermined limit and below a maximum predetermined limit. In other words, the variation determination is not indicative of anomalies. Based on the outcome of the variation determination, variation engine 137 determines an action to take from list of potential actions 320. The variation here was determined to be within an acceptable predetermined range defined by the maximum limit and minimum limit, resulting in the determination that the action to take should be continue data corruption detection 321. Variation engine 137 then performs continue data corruption detection 321. In some examples, measured variations can be grouped by association to a user identification in order to identify potentially malicious users or particular user credentials being used by malware attackers.

In some embodiments, the action to be taken is based on the magnitude of the variation identified in the comparison of vectors 310c. For example, where the magnitude of the variation falls in one particular range, specific actions such as execute a snapshot and run a malware scanner can be carried out. Similarly, where the magnitude of the variation falls in another particular range, specific actions such as alerting an administrator can be carried out. In some variation ranges, multiple actions may be carried out.

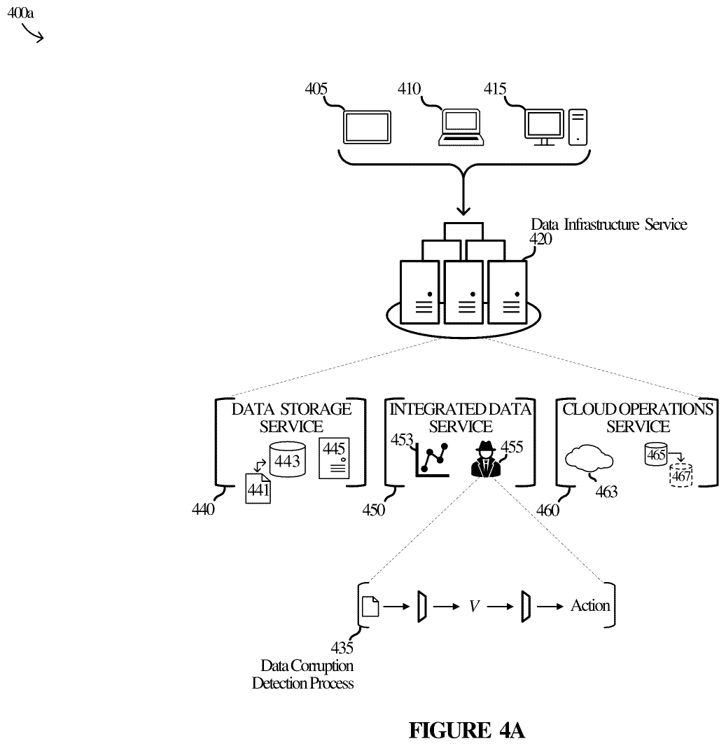

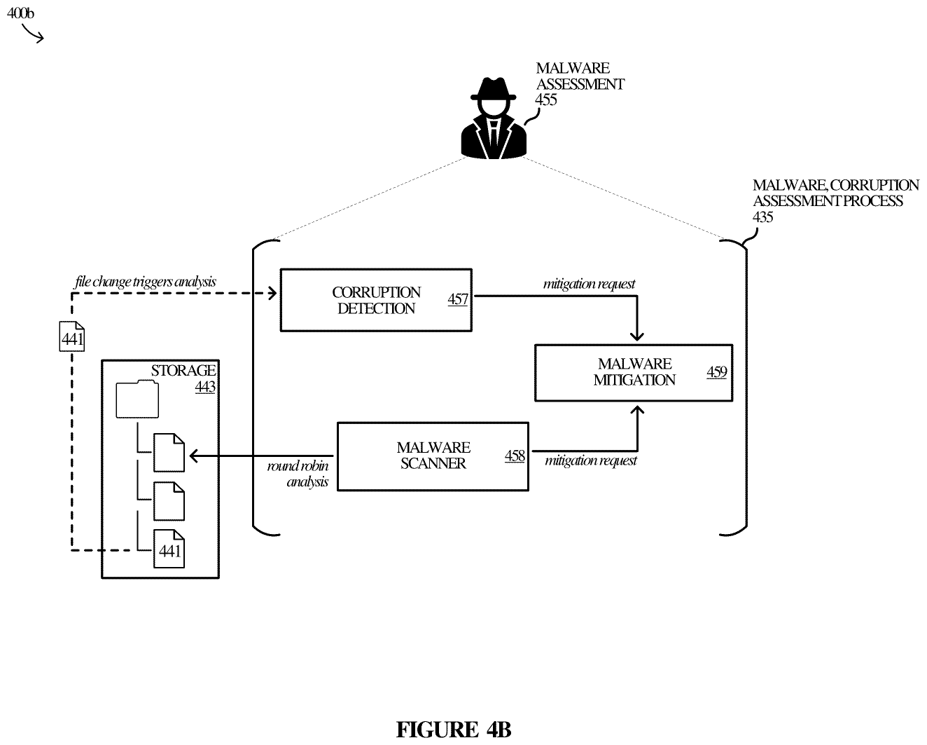

FIG. 4A illustrates another computing environment in an implementation, represented by computing environment 400a. Computing environment 400 includes user device 405, user device 410, and data infrastructure service 420. Data infrastructure service 420 includes data storage service 440, integrated data service 450, and cloud operations service 460.

Computing environment 400a is generally representative of a computing environment in which a data infrastructure service, such as data infrastructure service 420, operates. In an example, computing environment 400a is an enterprise environment.

Each of user device 405, user device 410, and user device 415 are generally representative of a user device sufficient to communicate with data infrastructure service 420. User device 405 is illustrated as a tablet computer, user device 410 is illustrated as a laptop computer, and user device 415 is illustrated as a desktop computer. Note that any number of user devices may communicate with data infrastructure service 420 and may be comprised of any number of a variety of computing devices, of which user device 405, user device 410, and user device 415 are each generally representative.

Data infrastructure service 420 is representative of a computing device that enables services through features that support various storage protocols, data tiering, deduplication, encryption, high availability, amongst other potential features. In computing environment 400a, an organization uses data infrastructure service 420 to provide data storage service 440, integrated data service 450, and cloud operations service 460.

Data storage service 440 is generally representative of a data storage component of data infrastructure service 420. Data storage service 440 includes storage 443 and server 445, each of which are generally representative of media for storing data. Storage 443 stores file 441. With respect to data corruption detection process 435, a file to be used in a vector comparison may be identified from the files stored in any number of locations within data storage service 440, an example of which is generally represented by file 441.

Integrated data service 450 is generally representative of an integrated data service component of data infrastructure service 420. Integrated data service 450 includes data analytics and insights 453 and malware assessment 455. Other examples of integrated data service 450 include data backup and recovery, data replication, data deduplication, data compression, data tiering, and the like. Malware assessment 455 is generally representative of a process for detecting malware that comprises data corruption detection process 435 as well as a round robin file system scanning to detect malware. Data corruption detection process 435 is generally representative of the steps of a process for detecting malware via vector comparison, though malware assessment 455 may contain other cybersecurity and cyberresilience processes and tools.

Cloud operations service 460 is generally representative of a cloud operations component of data infrastructure service 420. Cloud operations service 460 includes cloud storage 463 and a backup process illustrated by data 465 and back up 467. With respect to data corruption detection process 430, a file for use in a vector comparison may be identified from the files stored in cloud storage 463.

In an example operation, user device 405, user device 410, and user device 415 communicate with data infrastructure service 420. Where malware assessment 455 is enabled, data infrastructure service 420 executes data corruption detection process 430 and a malware scanning process. Other example operations of malware assessment 455 may include different cyberresilience and cybersecurity tools and processes. A user enables malware assessment 455, causing data infrastructure service 420 to begin data corruption detection process 430 by identifying a portion of a file to be used in a vector comparison. Data infrastructure service 420 generates a vector for the portion and compares the vector to one other vector corresponding to one other portion of the file. By comparing the vector and the one other vector, data infrastructure service 420 determines a variation for the vector. Data infrastructure service 420 then determines an action to perform with respect to the file based on the variation and performs the action with respect to the file.

FIG. 4B illustrates computing environment 400a in further detail, represented by computing environment 400b. Computing environment 400b includes malware assessment 455 and storage 443, which stores file 441. Malware assessment 455 is the same element as malware assessment 455 of FIG. 4A. Malware assessment 455 of FIG. 4B further includes data corruption detection process 435.

Data corruption detection process 435 includes data corruption detection 457, malware scanner 458, and malware mitigation 459. Data corruption detection process 435 is generally representative of a process for detecting the presence of malware in files with a data corruption detection process and a malware scanning process, as performed by data corruption detection 457 and malware scanner 458, respectively. An example of a data corruption detection process is illustrated by data corruption detection process 430 of FIG. 4A.

File 441 is the same as file 441 of FIG. 4A. File 441 may be stored via a data storage service of a data infrastructure service, such as data storage service 440 of data infrastructure service 420 illustrated in FIG. 4A. Integrated data service 450 may be carried out with respect to the files stored in storage 443, or with respect to files stored remotely to data infrastructure service 420.

Data corruption detection 457 is configured to receive a recently modified file to be used in a vector comparison. The recently modified file is stored in storage 443 but may be stored in a number of local or remote locations. File 441 is generally representative of a recently modified file. Upon receiving file 441, data corruption detection 457 performs a vector comparison. Where the vector variation exceeds a threshold criteria, a mitigation request is submitted to malware mitigation 459.

Malware scanner 458 is configured to scan all of the files in storage 443, including file 441. Malware scanner 458 scans each of the files of storage 443 in turn, and where evidence of a malware attack is detected, a mitigation request is sent to malware mitigation 459.

Data corruption detection 457 and malware scanner 458 may operate independently of each other and can execute alternative forms of data corruption detection in parallel. Notably, there may be a delay in time between the execution of a malware attack and the detection of the malware by malware scanner 458. This is because in using a round robin style of file scanning, malware scanner 458 may not scan the changed file before scanning a number of other files, the scanning of each of which requires time and resources. Data corruption detection 457 does not experience this delay, as the vector comparison performed by data corruption detection 457 can be triggered specifically by a change to a file. To evaluate the recency of a change to a file, data corruption detection 457 may use file metadata.

For example, where a malware attack modifies file 441, data corruption detection 457 immediately begins a vector comparison on file 441. Malware scanner 458 may not, by this point, have detected any malware attack at all. It is not until the round robin schema used by malware scanner 458 reaches file 441 in the round robin queue that a problem can be detected.

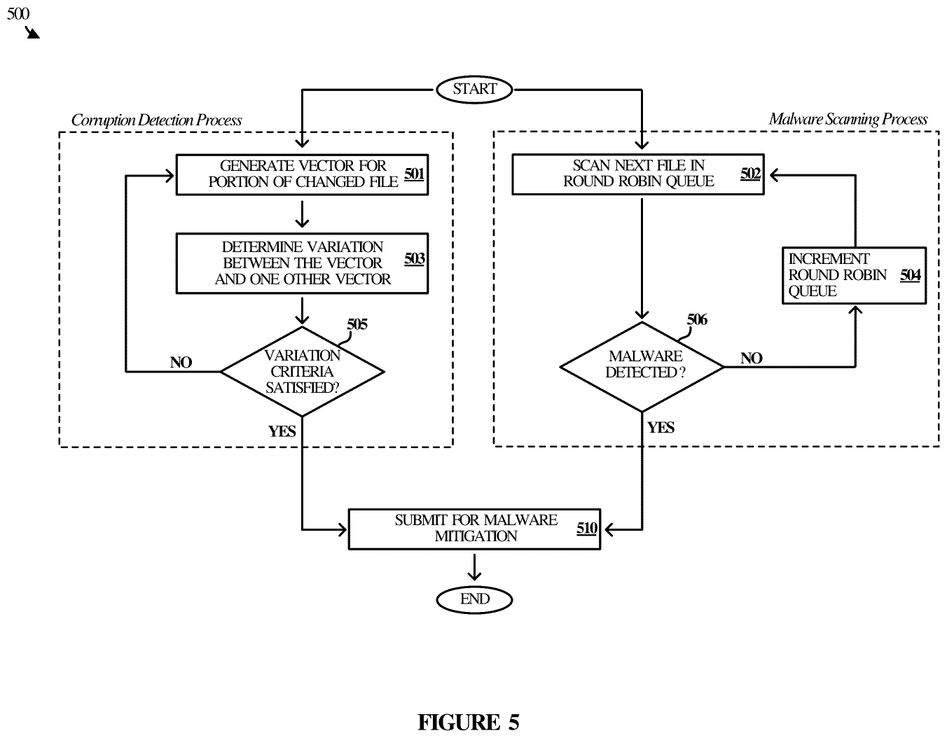

FIG. 5 illustrates an application of data corruption detection process 435 in an implementation. Data corruption detection process 500 may be implemented in program instructions in the context of the software and/or firmware elements of data infrastructure service 420 of FIG. 4A and FIG. 4B. The program instructions, when executed by one or more processing devices of one or more computing systems (e.g., computing device 805 in FIG. 8), direct the one or more computing systems to operate as follows, referring parenthetically to the steps in FIG. 5, and in the singular to a computing device for the sake of clarity.

To begin, a malware assessment process initiates a data corruption detection process and a malware scanning process. Referring first to the data corruption detection process. To initiate the data corruption detection process, a security engine of a data infrastructure service generates a vector having multiple dimensions for a portion of a file to be used in a vector comparison (step 501). Each dimension of the multiple dimensions of the vector corresponds to a feature of the portion of the file. A variation engine of the data infrastructure service determines a variation between the vector and one other vector based on one other portion of the file (step 503). The variation engine determines if the variation exceeds a threshold criteria (step 505). Where the variation between the vector and one other vector does not exceed a threshold criteria, the security engine of the data infrastructure service repeats the data corruption detection process. Where the variation between the vector and one other vector does exceed a threshold criteria, the security engine submits a request for malware mitigation to a malware mitigation process (step 510).

Now referring to the malware scanning process. To initiate the malware scanning process, the data infrastructure service scans a file in a round robin queue (step 502). Where malware is detected (step 504), the data infrastructure service submits a request for malware mitigation to a malware mitigation process (step 510). Where malware is not detected (step 506), the data infrastructure service increments a round robin queue (step 506) and repeats the process.

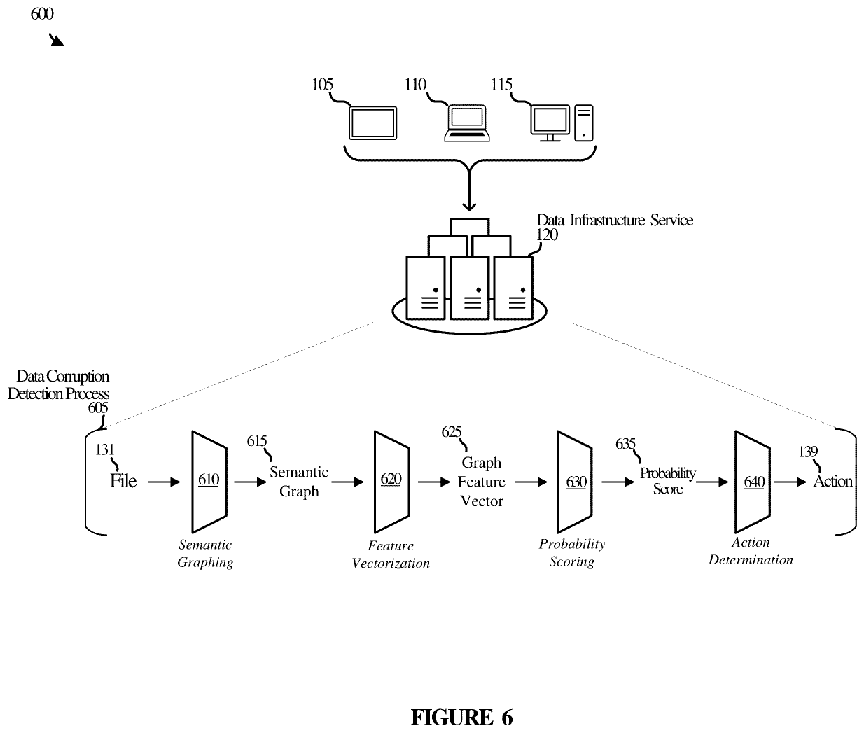

FIG. 6 illustrates another computing environment according to an implementation, represented by environment 600. Environment 600 includes user device 105, user device 110, and data infrastructure service 120, each of FIG. 1, respectively. Each of user device 105, user device 110, and data infrastructure service 120 are described in further detail in the text associated with FIG. 1. Data infrastructure service 120 includes data corruption detection process 605. Similarly to the malware detection process described in FIG. 5, data corruption detection process 605 can be performed in conjunction with the malware scanning process described in FIG. 5.

Data corruption detection process 605 is an alternative method for detecting the anomalous conditions that are consistent with the presence of malware (e.g., ransomware) or some other source of data corruption (i.e., mistaken copy and paste). Data corruption detection process 605 evaluates the integrity of a file to identify the effects of data corruption. To evaluate file integrity, data corruption detection process 605 identifies file 131. File 131 is generally representative of a text file but may be other file types whose content can be represented by a visual mapping of entities, events, and relationships. File 131 is fed to semantic graphing 610.

Semantic graphing 610 extracts elements from the content of file 131 in the form of event nodes and entity nodes. An event node generally represents some occurrence, while an entity node generally represents some person, place, or thing. For example, in a document about automobile maintenance, entity nodes may include an owner, an operator, an engine, and gasoline, while event nodes may include engine ignition, refueling, and observation of dashboard instruments.

Event nodes and entity nodes extracted from file 131 are used to create a semantic graph of file 131. Each event node and entity node are evaluated with respect to other event nodes and entity nodes of file 131 to determine how each node corresponds to each of the other nodes. A relationship may be a causal chain relationship (A results in B), a common cause relationship (A and B cause C), a common effect relationship (A causes B and C), or any other relationship paradigm. For example, failing to study for an exam and failing the exam are linked by a causal chain relationship, wherein failing to study for an exam brings about failing the exam.

With all of the event nodes and entity nodes extracted and their relationships evaluated, semantic graph 615 is created by generating a visual depiction of each event node, each entity node, and each relationship. In some cases, information about the relationship is depicted in the semantic graph. For example, a high degree of semantic correlation may be represented by a relatively high line weight, while a low degree of semantic correlation may be represented by a relatively low line weight. Other examples to classify relationships may include color coding or the length of the lines used to denote relationships. In some cases, event nodes and entity nodes may be classified using similar frameworks (size of visual depiction, color of visual depiction, etc.).

Semantic graph 615 may be an initial semantic graph for file 131 or a semantic graph created for file 131 in response to file 131 undergoing a change. Where semantic graph 615 is created in response to a change to file 131, semantic graphing 610 identifies the portion of file 131 corresponding to the change. Event nodes and entity nodes are extracted from the portion of file 131 corresponding to the change, which facilitates the generation of a subsequent semantic graph. In some cases, the portion of file 131 corresponding to the change in file 131 contains event nodes or entity nodes that do not have relationships to existing event nodes and entity nodes illustrated in the initial graph. Here, a subsequent semantic graph is generated that includes both the event nodes and entity nodes of the initial semantic graph and a sub-graph made up of the event nodes and entity nodes extracted from the portion of file 131 corresponding to the change. The existence of a sub-graph with nodes that are isolated from the nodes of the initial semantic graph is not definitive of the presence of malware, but it may constitute evidence weighing in favor of such a finding.

Semantic graph 615 is delivered to feature vectorization 620. Feature vectorization 620 generates graph feature vector 625 for file 131. Graph feature vector 625 is generated based on one or more semantic graphs and one or more sub-graphs included therein. In some examples, a first graph feature vector and a subsequent graph feature vector can be leveraged for vector variance analysis as described in the foregoing text. In some examples, semantic graph 615, and potentially other semantic graphs for file 131, are submitted to a large language artificial intelligence model (LLM).

The LLM receives the input corresponding to file 131 and returns a probability score associated with a degree of risk for file 131. In some cases, the prompt submitted to the LLM includes graph structural details in a textual format, such as in a JSON format. A high probability score corresponds to a high degree of risk that a semantic discrepancy relates to the presence of malware. The LLM generates the probability score for file 131 based on metrics such as one or more node relationships, the relevance of one or more nodes to an overall document type, whether the modifying user is the document's owner, an “in-degree” for one or more nodes, (connections to the event node or entity node), an “out-degree” for one or more nodes (connections from the event node or entity node), a number of semantic graphs, a number of semantic sub-graphs, the volume of entity nodes, the volume of event nodes, and the distribution of event nodes and entity nodes. In some cases, a machine learning model is specifically trained on combinations of files and probability scores and receives semantic graph 615 as an input.

Determining that a semantic discrepancy is present may be based on satisfying a predetermined threshold of discrepancy for probability scores. The predetermined threshold of discrepancy may be selected by an administrator. Where, for example, file 131 contains sensitive personal information, a low threshold of discrepancy may be selected, resulting in higher sensitivity to potential data integrity anomalies in file 131. In such an examples, lower probability scores may result in responsive action that would otherwise require a higher probability score. Alternatively, where file 131 contains common system operating code, a higher threshold of discrepancy may be selected, resulting in lower sensitivity to potential data integrity anomalies in file 131. In such an examples, higher probability scores may result in responsive action that would otherwise be applied to a lower probability score. Further, one or more thresholds of discrepancy may be selected based on the efficient allocation of resources.

In response to the identification of a semantic discrepancy that is beyond the threshold of discrepancy, data corruption detection process 605 initiates responsive action in the form of action 139. Action 139 may include alerting an administrator regarding the semantic discrepancy, initiating further evaluation to identify the presence of malware or ransomware, and taking mitigative action where any form of malware is identified. An example of further evaluation to identify ransomware is textual analysis of the file's contents. Examples of mitigative action include locking computing system access, isolating portions of the computing system, securing backups, alerting users, and the like.

Data corruption detection process 605 may also determine whether the data integrity anomaly in file 131 is malicious. A data integrity anomaly is malicious if the content includes encrypted data indicative of a ransomware application, the content includes code in a standard text file, or the content includes some other data indicative of a potential threat. If the data integrity anomaly is classified as malicious, data corruption detection process 605 initiates different actions to remediate the threat over a data integrity anomaly that is deemed non-malicious (or created from potential user error). For example, if a data integrity anomaly is not considered malicious, then a notification can be provided to a user or an administrator notifying the recipient of the anomaly identified in file 131 (e.g., potential copy/paste error). Otherwise, if a data integrity anomaly is considered malicious, a notification is generated, and remediation operations are used to prevent file 131 from being stored, to quarantine file 131, to limit access the datastore containing file 131, or to provide some other remediation operation.

In some implementations, action 139 is based on the type of content giving rise to the semantic discrepancy in file 131 (i.e., mistaken content or malicious content). In some examples, a semantic discrepancy occurs due to a mistake of a user where the anomalous content was accidentally included in file 131 (e.g., copy-paste error). In other examples, the semantic discrepancy occurs because of a malicious software application, such as ransomware that encrypts files or entire systems and demands payment, often in cryptocurrency, for their release. When encryption or other evidence confirming the presence of ransomware is identified, action 139 initiates a remediation action that prevents file 131 from being stored, quarantines file 131, reverts file 131 to a previous version, or provides some other remediation operation for file 131. For example, a modification to file 131 can include malicious code. In response, an action is executed to mitigate the threat posed by the code in file 131. The action can remove the code, revert file 131 to a previous version, notify an administrator, or provide some other action in association with file 131. In some further examples, a semantic discrepancy may be the result of a hallucinatory output by a generative artificial intelligence model.

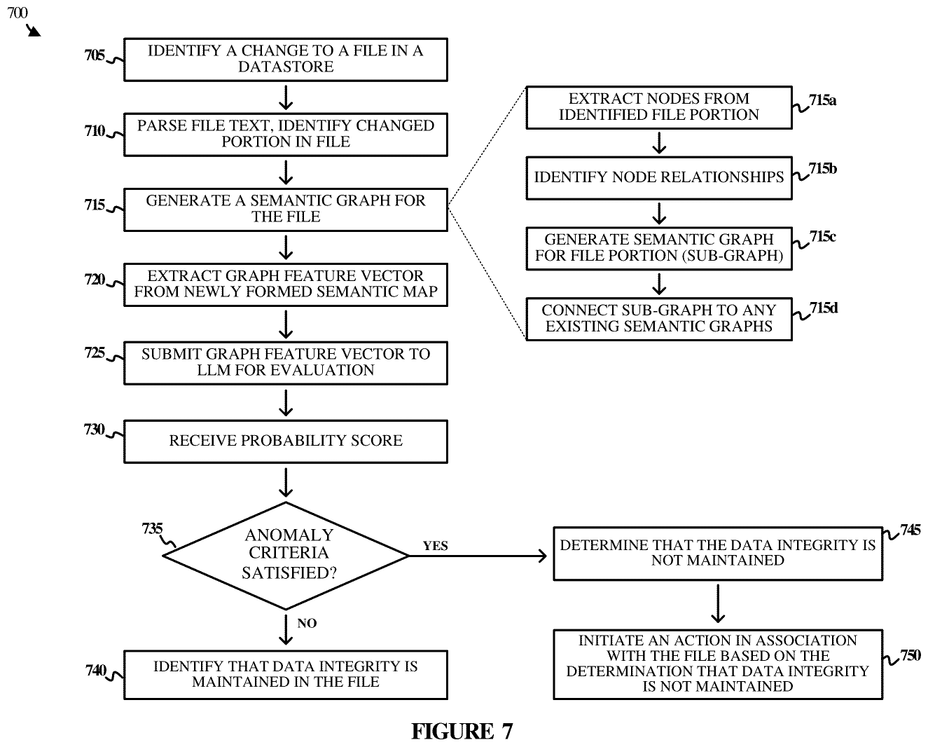

FIG. 7 illustrates operation 700 of a computing device to identify and manage data integrity anomalies in files according to an implementation. The steps of operation 700 are referenced parenthetically in the paragraphs that follow and may be carried out in the context of the systems and elements of environment 600 of FIG. 6.

To begin operation 700, a data infrastructure service (e.g., data infrastructure service 120) identifies a file (e.g., file 131) in a datastore (step 705). In some implementations, the file is identified when a write is requested by a user. In other implementations, the data infrastructure service identifies the file based on a threat identified in the data storage computing system, at the request of an administrator, at random, or by some other mechanism. A threat includes malware that is a broad term encompassing any software specifically designed to harm or exploit computer systems, networks, or users. It includes viruses, worms, spyware, and other harmful programs intended to disrupt, damage, or gain unauthorized access to computers or data. For example, malware could encrypt, add, or damage the data included in the file.

The text file is parsed (step 710). In some embodiments, parsing the text file includes identifying a portion of the file that corresponds to a change to the content of the file. Based on the parsed content of the file, the data infrastructure service generates a semantic graph for the file (step 715). Step 715 includes sub-step 715a, sub-step 715b, sub-step 715c, and sub-step 715d. First, event nodes and entity nodes are extracted from the portion of the file giving rise to the change (step 715a). Relationships are identified between each of the entity nodes and event nodes extracted from the portion of the file (step 715b). To create the semantic graph, the event nodes, entity nodes, and respective relationships are visually depicted. Here, the nodes and relationships extracted from the portion of the file are visually depicted to form a sub-graph (step 715c). The sub-graph is representative of the semantic characteristics of the changed file content contained in the portion. Generating the semantic sub-graph may include leveraging a large language artificial intelligence model (LLM) to extract the nodes and relationships from the file and to visually depict the nodes and relationships.

Event nodes and entity nodes can be related by a variety of casual relationship schemes with varying degrees of semantic correlation. For example, the degree of semantic correlation for the causal relationship between using all of the gas in your car's gas tank and needing to refuel before continuing to operate the vehicle is relatively strong, as the first concept is a direct cause of the second concept. In another example, the degree of semantic correlation for the causal relationship between going on vacation and failing an exam is weaker than the preceding example, because going on vacation did not directly cause the exam failure. Instead, going on vacation reduced the available time for studying, which made studying more stressful and less effective, which resulted in failing the exam. While the two concepts are still tied together in a way where one has a significant effect on the other, the two concepts are less proximate because of the number of intermediary concepts between them. In some cases, the degree of semantic correlation is also visually depicted in the semantic graph through color coding, line weights, or by some other visual classification sufficient to distinguish varying degrees of semantic correlation.

Based on the semantic characteristics of the nodes and relationships in the sub-graph, the sub-graph is connected to any existing semantic graphs for the file (step 715d). For example, where a sub-graph contained an entity node that semantically corresponds to an entity node in an existing semantic graph, the sub-graph is connected to the existing semantic graph via a connection between those two entity nodes. In some cases, a sub-graph does not directly connect to an existing semantic graph but does not constitute a semantic anomaly. In other cases, a sub-graph may connect to an existing semantic graph but still constitutes a semantic discrepancy such that responsive action is taken. In either case, the feature vector generated for the file is generated based on the sub-graph and any existing semantic graphs, whether the sub-graph connects to the existing semantic graph or not.

With the semantic graph generated for the file (the sub-graph and any existing semantic graphs), a feature vector is generated for semantic graph (step 720). The graph feature vector is generated based on metrics such as one or more node relationships, the relevance of one or more nodes to an overall document type, whether the modifying user is the document's owner, an “in-degree” for one or more nodes, (connections to the event node or entity node), an “out-degree” for one or more nodes (connections from the event node or entity node), a number of semantic graphs, a number of semantic sub-graphs, the volume of entity nodes, the volume of event nodes, and the distribution of event nodes and entity nodes. In some embodiments, a prompt template is used that is configured to streamline the creation of a prompt that instructs the LLM to create the graph feature vector.

The graph feature vector is processed by an artificial intelligence model configured to take an input of the graph feature vector, or data associated with the graph feature vector, and to return a probability score for the file (step 725). Where the returned probability score is high, the risk that the semantic anomaly detected is problematic (i.e., malware) is relatively high. Where the returned probability score is low, the risk that the semantic anomaly detected is problematic (i.e., malware) is relatively low. Using the probability score, a determination is made regarding the semantic integrity of the file (step 735). What conclusions are drawn from which probability score value can be customized based on the overall security needs of the system, the type of file currently being examined, the content in the file giving rise to the potential semantic discrepancy, and the like.

Where, based on an evaluation of the graph feature vector, the data storage computing system determines that no semantic discrepancy is present, data integrity for the file has been maintained (step 740). In some cases, an indication that file integrity has been maintained is generated and transmitted to a user or administrator.

Where, based on an evaluation of the graph feature vector, the data storage computing system determines that a semantic discrepancy is present, data integrity for the file has not been maintained (step 745). In some cases, an indication that file integrity has not been maintained is generated and transmitted to a user or administrator.

In response to identifying that file integrity has not been maintained, responsive action associated with the file is taken (step 750). In some implementations, data storage computing system notifies an administrator of the data integrity threat, and an indication of the file content associated with the data integrity anomaly. Alternatively, or in addition to notifying the administrator, the data storage computing system prevents the file from being saved, maintains a snapshot of the datastore in which the file is contained, reverts the file to a previous state, or provides some other action on the file.

In some examples, the action associated with the file is selected based on a determination of whether the data integrity anomaly is malicious. For example, data integrity anomalies can be created maliciously (injection of malicious code, ransomware, etc.) or by mistake associated with the user accessing the file (copy-paste error, accidental deletion, flawed software update, and the like). The data storage computing system can determine whether the data integrity anomaly is malicious based on a variety of factors, such as determining whether the content giving rise to the semantic discrepancy includes encrypted data indicative of a ransomware attacked, determining whether the content giving rise to the semantic discrepancy includes portions of executable code that could potentially implement a malicious process, or based on some other factor. The responsive action corresponding to a malicious attack would be more conservative than the responsive actions associated with a non-malicious semantic discrepancy. For example, a responsive action to a malicious attack can prevent the file in question from being stored in the datastore and can limit future user access, while a responsive action to a non-malicious data integrity anomaly provides a notification to an administrator for further analysis.

In some embodiments, the criteria for identifying the data integrity anomaly in the file is configurable. For example, in a first deployment environment, an administrator provides input indicating a more conservative policy on data integrity. Accordingly, the criteria (or thresholds) are at a first size that is more likely to identify smaller data integrity anomalies in the file. However, in a second deployment environment, an administrator provides input indicating a more lenient policy on data integrity. Consequently, the criteria (or thresholds) are updated to identify larger data integrity anomalies in the file, while limiting the detection of smaller data integrity anomalies.

FIG. 8 illustrates computing device 805, which is representative of any system or collection of systems in which the various applications, processes, services, and scenarios disclosed herein may be implemented. Examples of computing device 805 include, but are not limited to server computers, web servers, cloud computing platforms, and data center equipment, as well as any other type of physical or virtual server machine, container, and any variation or combination thereof. (In some examples, computing device 805 may also be representative of desktop and laptop computers, tablet computers, and the like.)

Computing device 805 may be implemented as a single apparatus, system, or device or may be implemented in a distributed manner as multiple apparatuses, systems, or devices. Computing device 805 includes, but is not limited to, processing system 825, storage system 810, software 815, communication interface system 820, and user interface system 830. Processing system 825 is operatively coupled with storage system 810, communication interface system 820, and user interface system 830.

Processing system 825 loads and executes software 815 from storage system 810. Software 815 includes and implements data corruption detection process 835, which is representative of the processes discussed with respect to the preceding Figures, such as data corruption detection process 200. When executed by processing system 825, software 815 directs processing system 825 to operate as described herein for at least the various processes, operational scenarios, and sequences discussed in the foregoing implementations. Computing device 805 may optionally include additional devices, features, or functionality not discussed for purposes of brevity.

Referring still to FIG. 8, processing system 825 may include a micro-processor and other circuitry that retrieves and executes software 815 from storage system 810. Processing system 825 may be implemented within a single processing device but may also be distributed across multiple processing devices or sub-systems that cooperate in executing program instructions. Examples of processing system 825 include general purpose central processing units, microcontroller units, graphical processing units, application specific processors, integrated circuits, application specific integrated circuits, and logic devices, as well as any other type of processing device, combinations, or variations thereof.

Storage system 810 may comprise any computer readable storage media readable by processing system 825 and capable of storing software 815. Storage system 810 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 810 may be implemented as a single storage device but may also be implemented across multiple storage devices or sub-systems co-located or distributed relative to each other. Storage system 810 may comprise additional elements, such as a controller, capable of communicating with processing system 825 or possibly other systems.

Software 815 (including data corruption detection process 835) may be implemented in program instructions and among other functions may, when executed by processing system 825, direct processing system 825 to operate as described with respect to the various operational scenarios, sequences, and processes illustrated herein. For example, software 815 may include program instructions for implementing data corruption detection processes and procedures as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 815 may include additional processes, programs, or components, such as operating system software, virtualization software, or other application software. Software 815 may also comprise firmware or some other form of machine-readable processing instructions executable by processing system 825.

In general, software 815, when loaded into processing system 825 and executed, transforms a suitable apparatus, system, or device (of which computing device 805 is representative) overall from a general-purpose computing system into a special-purpose computing system customized to support data corruption detection as described herein. Indeed, encoding software 815 on storage system 810 may transform the physical structure of storage system 810. The specific transformation of the physical structure may depend on various factors in different implementations of this description. Examples of such factors may include, but are not limited to, the technology used to implement the storage media of storage system 810 and whether the computer-storage media are characterized as primary or secondary storage, as well as other factors.

For example, if the computer readable storage media are implemented as semiconductor-based memory, software 815 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 820 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 805 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method of operating a computing device, the method comprising:
identifying a file in a datastore having undergone a content revision;
generating, for the content revision of the file, a semantic graph for the file based on the content revision, wherein generating the semantic graph comprises:
extracting, from a portion of the file associated with the content revision, one or more entity nodes and one or more event nodes, and
identifying one or more semantic node relationships;
generating, for the file, an updated semantic graph, wherein generating the updated semantic graph comprises:
correlating, based on node relationships, the semantic graph with any existing semantic graphs for the file or any existing semantic sub-graphs for the file based on semantic node relationships between the semantic graph and the any existing semantic graphs or semantic sub-graphs;
extracting, from the updated semantic graph, a graph feature vector for the file;
determining, based on an evaluation of graph feature vector, a probability score for the file; and
initiating, based on the probability score, one or more actions in association with the file.

2. The method of claim 1, wherein:
extracting the graph feature vector from the updated semantic graph comprises submitting the updated semantic graph to a machine learning model;
the machine learning model is trained on training data including graph feature vectors, a number of files corresponding to the graph feature vectors, and probability scores corresponding to the file; and
the machine learning model is configured to receive a graph feature vector as an input.

3. The method of claim 1, wherein:
the one or more actions comprise malware mitigation;
performing the one or more actions comprises performing the malware mitigation; and
wherein performing the malware mitigation comprises checking the file for evidence of a malware event.

4. The method of claim 2, wherein:
the one or more actions comprise editing assistance;
performing the one or more actions comprises performing the editing assistance; and
wherein performing the editing assistance comprises checking the file for editing errors.

5. The method of claim 1, wherein:
the file comprises plain text data, image data, or a combination thereof; and
generating the semantic graph for the file having image data comprises leveraging an image-to-text processing model to obtain a textual representation of the image data.

6. The method of claim 1, wherein extracting the graph feature vector from the updated semantic graph for the file is performed in part based on an evaluation of one or more of:
one or more semantic graphs for the file;
one or more semantic sub-graphs for the file;
a number of, and corresponding sizes of, the one or more semantic graphs for the file and the one or more semantic sub-graphs for the file;
a volume of nodes for the file;
a distribution of event nodes and entity nodes for the file;
one or more node relationships for the file;
a relevance of a node to a document type for the file;
if a user modifying the file is an owner of the file; and
a node “in-degree” and node “out-degree” for the file.

7. The method of claim 1, wherein identifying the file in the datastore comprises identifying a write request to the file in the datastore.

8. A computing apparatus comprising:
a storage system;
a processor operatively coupled to the storage system; and
program instructions stored on the storage system that, when executed by a processing system, direct the processing system to:
identify a file in a datastore having undergone a content revision;
generate, for the content revision of the file, a semantic graph for the file based on the content revision, wherein generating the semantic graph comprises:
extracting, from a portion of the file associated with the content revision, one or more entity nodes and one or more event nodes, and
identifying one or more semantic node relationships;
generate, for the file, an updated semantic graph, wherein generating the updated semantic graph comprises:
correlating, based on node relationships, the semantic graph with any existing semantic graphs for the file or any existing semantic sub-graphs for the file based on semantic node relationships between the semantic graph and the any existing semantic graphs or semantic sub-graphs;
extract, from the updated semantic graph, a graph feature vector for the file;
determine, based on an evaluation of graph feature vector, a probability score for the file; and
initiate, based on the probability score, one or more actions in association with the file.

9. The computing apparatus of claim 8, wherein:
the program instructions directing the processor to extract the graph feature vector from the updated semantic graph further comprise instructions that, when executed, direct the processor to submit the updated semantic graph to a machine learning model;
the machine learning model is trained on training data including graph feature vectors, a number of files corresponding to the graph feature vectors, and probability scores corresponding to the file; and
the program instructions further include instructions that, when executed, cause the processor to configure the machine learning model to receive a graph feature vector as an input.

10. The computing apparatus of claim 8, wherein:
the one or more actions comprise malware mitigation;
the program instructions directing the processor to perform the one or more actions further comprise instructions that, when executed, cause the processor to perform the malware mitigation; and
the program instructions directing the processor to perform the malware mitigation further comprise instructions that, when executed, cause the processor to check the file for evidence of a malware event.

11. The computing apparatus of claim 9, wherein:
the one or more actions comprise editing assistance;
the program instructions directing the processor to perform the one or more actions further comprise instructions that, when executed, cause the processor to perform performing the editing assistance; and
the program instructions directing the processor to perform the editing assistance further comprise instructions that, when executed, cause the processor to check the file for editing errors.

12. The computing apparatus of claim 8, wherein:
the file comprises plain text data, image data, or a combination thereof; and
the program instructions directing the processor to generate the semantic graph for the file having image data further comprise instructions that, when executed, cause the processor to leverage an image-to-text processing model to obtain a textual representation of the image data.

13. The computing apparatus of claim 8, wherein the program instructions directing the processor to extract the graph feature vector from the updated semantic graph for the file further comprise instructions that, when execute, cause the processor to extract the graph feature vector based in part on an evaluation of one or more of:
one or more semantic graphs for the file;
one or more semantic sub-graphs for the file;
a number of, and corresponding sizes of, the one or more semantic graphs for the file and the one or more semantic sub-graphs for the file;
a volume of nodes for the file;
a distribution of event nodes and entity nodes for the file;
one or more node relationships for the file;
a relevance of a node to a document type for the file;
if a user modifying the file is an owner of the file; and
a node “in-degree” and node “out-degree” for the file.

14. The computing apparatus of claim 8, wherein identifying the file in the datastore comprises identifying a write request to the file in the datastore.

15. One or more computer readable storage media having program instructions stored thereon that, when executed by at least one processor of a computing device, direct the computing device to:
identify a file in a datastore having undergone a content revision;
generate, for the content revision of the file, a semantic graph for the file based on the content revision, wherein generating the semantic graph comprises:
extracting, from a portion of the file associated with the content revision, one or more entity nodes and one or more event nodes, and
identifying one or more semantic node relationships;
generate, for the file, an updated semantic graph, wherein generating the updated semantic graph comprises:
correlating, based on node relationships, the semantic graph with any existing semantic graphs for the file or any existing semantic sub-graphs for the file based on semantic node relationships between the semantic graph and the any existing semantic graphs or semantic sub-graphs;
extract, from the updated semantic graph, a graph feature vector for the file;
determine, based on an evaluation of graph feature vector, a probability score for the file; and
initiate, based on the probability score, one or more actions in association with the file.

16. The one or more computer readable storage media of claim 15, wherein:
the program instructions directing the processor to extract the graph feature vector from the updated semantic graph further comprise instructions that, when executed, direct the processor to submit the updated semantic graph to a machine learning model;
the machine learning model is trained on training data including graph feature vectors, a number of files corresponding to the graph feature vectors, and probability scores corresponding to the file; and
the program instructions further include instructions that, when executed, cause the processor to configure the machine learning model to receive a graph feature vector as an input.

17. The one or more computer readable storage media of claim 15, wherein:
the one or more actions comprise malware mitigation;
the program instructions directing the processor to perform the one or more actions further comprise instructions that, when executed, cause the processor to perform the malware mitigation; and
the program instructions directing the processor to perform the malware mitigation further comprise instructions that, when executed, cause the processor to check the file for evidence of a malware event.

18. The one or more computer readable storage media of claim 16, wherein:
the one or more actions comprise editing assistance;
the program instructions directing the processor to perform the one or more actions further comprise instructions that, when executed, cause the processor to perform performing the editing assistance; and
the program instructions directing the processor to perform the editing assistance further comprise instructions that, when executed, cause the processor to check the file for editing errors.

19. The one or more computer readable storage media of claim 15, wherein:
the file comprises plain text data, image data, or a combination thereof; and
the program instructions directing the processor to generate the semantic graph for the file having image data further comprise instructions that, when executed, cause the processor to leverage an image-to-text processing model to obtain a textual representation of the image data.

20. The one or more computer readable storage media of claim 15, wherein the program instructions directing the processor to extract the graph feature vector from the updated semantic graph for the file further comprise instructions that, when execute, cause the processor to extract the graph feature vector based in part on an evaluation of one or more of:
one or more semantic graphs for the file;
one or more semantic sub-graphs for the file;
a number of, and corresponding sizes of, the one or more semantic graphs for the file and the one or more semantic sub-graphs for the file;
a volume of nodes for the file;
a distribution of event nodes and entity nodes for the file;
one or more node relationships for the file;
a relevance of a node to a document type for the file;
if a user modifying the file is an owner of the file; and
a node “in-degree” and node “out-degree” for the file.
